(19) United States
(12) Patent Application Publication
(10) Pub. No.: US 2011/0217471 A1
(43) Pub. Date: Sep. 8, 2011

(54) ONE-COMPONENT, AMBIENT CURABLE WATERBORNE COATING COMPOSITIONS, RELATED METHODS AND COATED SUBSTRATES

(76) Inventors: Irina G. Schwendeman, Wexford, PA (US); Venkateshwarlu Kalsani, Gibsonia, PA (US); Ronald R. Ambrose, Loganville, GA (US); Mary Ann Fuhry, Butler, PA (US); Shanti Swarup, Allison Park, PA (US); Anthony M. Chasser, Allison Park, PA (US); Jonathan T. Martz, Glenshaw, PA (US); Carol L. Boggs, Cheswick, PA (US)

(21) Appl. No.: 13/037,460

(22) Filed: Mar. 1, 2011

Related U.S. Application Data
(60) Provisional application No. 61/309,652, filed on Mar. 2, 2010.

(51) Int. Cl. B05D 3/02; C09D 175/04

(52) U.S. Cl. 427/385.5; 524/538; 524/501

(57) ABSTRACT

Disclosed are coating compositions that can be one-component, ambient curable, and waterborne. The coating compositions include a polycarbodiimide, a carboxylic acid functional polymer, and a base. The polycarbodiimide is modified for hydrophilicity and is derived from a tetramethylxylylene diisocyanate. The base is present in the composition in an amount sufficient to provide the composition with a pH of at least 9.0.

### CROSS-REFERENCE TO RELATED APPLICATION

This application claims the benefit of U.S. Provisional Patent Application Ser. No. 61/309,652, file Mar. 2, 2010, which is incorporated herein by reference in its entirety.

### FIELD OF THE INVENTION

The present invention relates to coating compositions. More particularly, the present invention relates to one-component, ambient curable, waterborne coating compositions. The present invention also relates to methods for making such coating compositions, substrates coated with a coating deposited from such compositions, as well as methods for depositing a coating on a substrate.

### BACKGROUND INFORMATION

Coating compositions in which all of the components are stored together in a single container are desirable in many cases from the standpoint of, for example, convenience to the end user. Among the properties that such coating compositions should exhibit is storage stability. In other words, the viscosity of the composition should not significantly increase over time to the point in which the composition is no longer suitable for convenient use for depositing a coating.

In many cases, it is desirable to use liquid coating compositions that are borne in water as opposed to organic solvents. This desire stems primarily from environmental concerns with the emission of volatile organic compounds (VOC) during the painting process.

It is also often desirable to provide coating compositions that are curable under ambient conditions of atmospheric temperature and pressure. Such compositions are, in many cases, preferable over, for example, thermally-cured or radiation cured coating compositions because (i) little or no energy is required to cure the composition, (ii) the materials from which some substrates are constructed cannot withstand elevated temperature cure conditions, and/or (iii) large or complex articles to be coated may not be convenient for processing through thermal or radiation cure equipment.

Carbodiimide compounds are known to react with a carboxyl group at ambient conditions. As a result, this chemistry has been employed to cross-link carboxyl functional resins in coating compositions. Such compositions have, however, had inadequate storage stability for wide use as a one component composition because of the reactivity of the carbodiimide groups and carboxyl groups.

As a result, it would be desirable to provide one-component, waterborne, ambient curable coating compositions based on carbodiimide-carboxyl chemistry, wherein such compositions exhibit dramatically improved storage stability as compared to the prior art.

### SUMMARY OF THE INVENTION

In certain respects, the present invention is directed to one component waterborne coating compositions. The coating compositions comprise: (a) a polycarbodiimide that is: (i) modified for hydrophilicity; and (ii) derived from a tetramethylxylylene diisocyanate; (b) a carboxylic acid functional polymer; and (c) a base in an amount greater than the theoretical amount necessary to neutralize 100% of the acid groups of the carboxylic acid functional polymer and sufficient to provide the composition with a pH of at least 9.0.

The present invention is also related to, inter alia, methods for making and using such coating compositions and substrates at least partially coated with a coating deposited from such compositions.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As previously mentioned, certain embodiments of the present invention are directed to coating compositions, such as one-component, waterborne, ambient curable coating compositions. As used herein, the term “one-component” refers to coating compositions in which all of the composition components are stored together in a single container and which are storage stable, which means that the viscosity of the composition does not significantly increase over time to the point in which the composition is no longer suitable for convenient use for depositing a coating. In fact, in certain embodiments, the one-component coating compositions of the present invention exhibit a pot life of three (3) months or more when stored at a temperature of 120° F. or 160° F. as evidenced by the lack of gelation of the composition when stored in a sealed container at those temperatures. It is believed that this translates into a pot life of 3 years or more when stored in a sealed container at ambient conditions of temperature and pressure.

As used herein, “waterborne” refers to coating compositions in which the solvent or carrier fluid for the coating composition primarily or principally comprises water. For example, in certain embodiments, the carrier fluid is at least 80 weight percent water, based on the total weight of the carrier fluid. Moreover, certain of the coating compositions of the present invention are “low VOC coating compositions”. As used herein, the term “low VOC composition” means that the composition contains no more than three (3) pounds of volatile organic compounds per gallon of the coating composition. As used herein, the term “volatile organic compound” refers to compounds that have at least one carbon atom and which are released from the composition during drying and/or curing thereof. Examples of “volatile organic compounds” include, but are not limited to, alcohols, benzenes, toluenes, chloroforms, and cyclohexanes.

As used herein, the term “ambient curable” refers to coating compositions that, following application to a substrate, are capable of curing in the presence of ambient air, the air having a relative humidity of 10 to 100 percent, such as 25 to 80 percent, and a temperature in the range of −10 to 120° C., such as 5 to 80° C., in some cases 10 to 60° C. and, in yet other cases, 15 to 40° C. As used herein, the term “cure” refers to a coating wherein any crosslinkable components of the composition are at least partially crosslinked. In certain embodiments, the crosslink density of the crosslinkable components, i.e., the degree of crosslinking, ranges from 5% to 100%, such as 35% to 85%, or, in some cases, 50% to 85% of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen.

As previously indicated, the coating compositions of the present invention comprise a polycarbodiimide. As used herein, the term “polycarbodiimide” refers to a polymer containing two or more units having the structure: —N═C═N—. As will be appreciated, polycarbodiimides can generally be prepared by condensation reacting a polyisocyanate in the presence of a suitable catalyst to form a polycarbodiimide having terminal NCO-functionality, as will be more fully described below.

In the present invention, however, the polyisocyanate from which the foregoing polycarbodiimide is derived is a tetramethylxylylene diisocyanate (“TMXDI”). TMXDI which is suitable for use in the present invention includes, for example, m-TMXDI, p-TMXDI, and mixtures thereof. These have the following structural formulae and can be produced by the methods described in, for example, U.S. Pat. Nos. 3,290,350, 4,130,577 and 4,439,616.

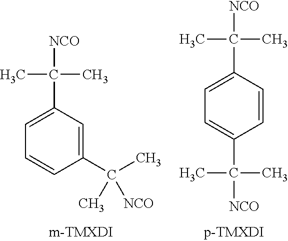

If desired, the polyisocyanate can be an NCO-containing adduct such as would be formed, for example, when an active hydrogen-containing compound chain extender is present before or during polycarbodiimide formation, as described below.

The active hydrogen-containing chain extender is a spacer linking polyisocyanates together or linking isocyanate functional polycarbodiimides together, depending upon when the active hydrogen compound is added. For example, the chain extender can be added before, during, or after formation of a polycarbodiimide having terminal NCO-functionality.

Any suitable compound containing active hydrogens may be used as the chain extender, if a chain extender is employed. The term “active hydrogen atoms” refers to hydrogens which, because of their position in the molecule, display activity according to the Zerewitinoff test. Accordingly, active hydrogens include hydrogen atoms attached to oxygen, nitrogen, or sulfur, and thus useful compounds will include those having at least two hydroxyl, thiol, primary amine, and/or secondary amine groups (in any combination). In certain embodiments, the active hydrogen-containing chain extender contains from 2 to 4 active hydrogens per molecule.

Examples of such compounds include amines, which includes polyamines, aminoalcohols, mercapto-terminated derivatives, and alcohols that includes polyhydroxy materials (polyols). Suitable polyhydroxyl materials, i.e. polyols, include low or high molecular weight materials and, in certain cases, have average hydroxyl values as determined by ASTM designation E-222-67, Method B, of 2000 and below, such as between below 2000 and 10. The term “polyol” is meant to include materials having an average of two or more hydroxyl groups per molecule.

Suitable polyols include low molecular weight diols, triols and higher alcohols, low molecular weight amide-containing polyols and higher polymeric polyols such as polyester polyols, polyether polyols, polycarbonate polyols and hydroxy-containing (meth)acrylic polymers. Such polymers often have hydroxyl values of from 10 to 180.

The low molecular weight diols, triols and higher alcohols useful in the instant invention often have hydroxy values of 200 or above, such as within the range of 200 to 2000. Such materials include aliphatic polyols, including alkylene polyols containing from 2 to 18 carbon atoms. Examples include ethylene glycol, 1,4-butanediol, 1,6-hexanediol; cycloaliphatic polyols such as 1,2-cyclohexanediol and cyclohexane dimethanol. Examples of triols and higher alcohols include trimethylol propane, glycerol and pentaerythritol. Also useful are polyols containing ether linkages such as diethylene glycol and triethylene glycol and oxyalkylated glycerol and longer chain diols such as dimer diol or hydroxy ethyl dimerate.

In certain embodiments of the present invention, the chain extender comprises a silicone diol, which refers to diols comprising a polysiloxane structure that includes alternating silicon and oxygen atoms. Specific examples of such chain extenders include, but are not limited to, KF 6001 (produced by Shin-Etsu Chemical Co., Ltd.), DMS-C15 (produced by Gelest Inc.), and Z-6018 from Dow Corning.

As mentioned above, to manufacture a polycarbodiimide used in the compositions of the present invention, an isocyanate terminated polycarbodiimide is first formed by condensation reacting a TMXDI, which may or may not have been previously chain extended by the reaction of a TMXDI with an active-hydrogen containing chain extender of the type previously described. The TMXDI is condensed with the elimination of carbon dioxide to form the isocyanate terminated polycarbodiimide.

The condensation reaction is typically conducted by taking a solution of a polyisocyanate and heating in the presence of suitable catalyst. Such reaction is described, for example, by K. Wagner et al., Angew. Chem. Int. Ed. Engl., vol. 20, p. 819-830 (1981). Representative examples of suitable catalysts are described in U.S. Pat. Nos. 2,941,988, 3,862,989 and 3,896,251, for example. Specific examples include 1-ethyl-3-phospholine, 1-ethyl-3-methyl-3-phospholine-1-oxide, 1-ethyl-3-methyl-3-phospholine-1-sulfide, 1-ethyl-3-methyl-phospholidine, 1-methylphospholen-1-oxide, 1-ethyl-3-methyl-phospholidine-1-oxide, 3-methyl-1-phenyl-3-phospholine-1-oxide and bicyclic terpene alkyl or hydrocarbyl aryl phosphine oxide or camphene phenyl phosphine oxide.

The particular amount of catalyst used will depend to a large extent on the reactivity of the catalyst itself and the polyisocyanate being used. A concentration range of 0.05-5 parts of catalyst per 100 parts of adduct is generally suitable.

The resulting polycarbodiimide has terminal isocyanate groups. In the present invention, the isocyanate terminated polycarbodiimide is then further reacted by reacting the terminal isocyanate groups with an active hydrogen-containing hydrophilic compound to impart hydrophilicity to the polycarbodiimide enabling it to be dispersed in water. As such, the polycarbodiimide is “modified for hydrophilicity”.

Suitable active hydrogen-containing hydrophilic compounds include monofunctional active hydrogen containing hydrophilic compounds, such as any mono hydroxyl functional, mono thiol functional, and/or mono amine (primary or secondary amine) functional compounds. In certain embodiments, however, the monofunctional active hydrogen containing hydrophilic compound comprises a polyether amine such as amines, often primary amines, having a polyether backbone, typically based on ethylene oxide or mixed ethylene oxide and propylene and having a molecular weight greater than 500, such as at least 1000 on a number average basis. Suitable amines include those described in paragraph [0037] of United States Patent Application Publication No. 2009-0246393 A1, the cited portion of which being incorporated herein by reference, which have the structure:

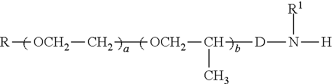

wherein R is C₁ to C₄ alkyl; a is 5 to 50 and b is 0 to 35, and when b is present the mole ratio of a to b is at least 1:1; R¹ is hydrogen or a hydrocarbon radical and D is a divalent linking group or a chemical bond.

Reaction of the polyether amine with the NCO-containing carbodiimide is often conducted with a stoichiometric equivalent of amine to NCO equivalents or a slight excess of amine and at a temperature typically from 80 to 110° C. until an IR spectrum of the reaction mixture indicates substantially no remaining NCO functionality. The Examples herein are illustrative. Suitable conditions for synthesis of the carbodiimides used in the coating compositions of the present invention are also described in United States Patent Application Publication No. 2009-0246393 A1 at [0043]-[0046] the cited portion of which being incorporated herein by reference.

The compositions of the present invention also comprise a carboxylic acid functional polymer, such as, for example, a carboxyl-containing polyester resin, acrylic resin and/or polyurethane resin.

Suitable carboxyl-containing polyester resins can be prepared by condensation in the conventional manner, such as from an alcohol component and an acid component. The polyester resin so referred to herein includes the so-called alkyd resins as well.

As to the above alcohol component, there may be specifically mentioned those having two or more hydroxy groups within each molecule, such as triols, including trimethylolpropane and hexanetriol, and diols, including propylene glycol, neopentyl glycol, butylene glycol, hexylene glycol, octylene glycol, 1,6-hexanediol, 1,8-octanediol, 1,9-nonanediol, 1,10-decanediol, 1,12-dodecanediol, 1,2-cyclohexanediol, 1,3-cyclohexanediol, 1,4-cyclohexanediol, hydrogenated bisphenol A, caprolactone diol and bishydroxyethyltaurine. The above alcohol component may comprise two or more species.

The above acid component includes those having two or more carboxyl groups within each molecule, for example aromatic dicarboxylic acids, such as phthalic acid and isophthalic acid, aliphatic dicarboxylic acids such as adipic acid, azelaic acid and tetrahydrophthalic acid, and tricarboxylic acids, such as trimellitic acid. Furthermore, mention may be made of long-chain fatty acids such as stearic acid, lauric acid and like ones, oleic acid, myristic acid and like unsaturated ones, natural fats or oils, such as castor oil, palm oil and soybean oil and modifications thereof. The above acid component may comprise two or more species.

Diacids and diols of fatty acids such as EMPOL 1010 fatty diacid from the Cognis Emery Group can be used or its corresponding diol can be used.

Furthermore, as the one having a hydroxyl group(s) and a carboxyl group(s) within each molecule, there may be mentioned hydroxycarboxylic acids such as dimethylolpropionic acid and the like.

In cases where the polyester resin obtained has hydroxy groups, the whole or part thereof may be modified with an acid anhydride, such as phthalic anhydride, succinic anhydride, hexahydrophthalic anhydride or trimellitic anhydride, so that the resin may have carboxyl groups.

Suitable carboxyl-containing acrylic resins can be obtained in the conventional manner, specifically by solution or emulsion polymerization, of a carboxyl-containing ethylenically unsaturated monomer and another ethylenically unsaturated monomer.

Exemplary carboxyl-containing ethylenically unsaturated monomers include acrylic acid, methacrylic acid, ethacrylic acid, crotonic acid, maleic acid, fumaric acid, itaconic acid, half esters thereof such as maleic acid ethyl ester, fumaric acid ethyl ester and itaconic acid ethyl ester, succinic acid mono(meth)acryloyloxyethyl ester, phthalic acid mono(meth)acryloyloxyethyl ester and the like, including mixtures thereof.

Exemplary other ethylenically unsaturated monomers include hydroxy-containing ethylenically unsaturated monomers, such as 2-hydroxyethyl acrylate, 2-hydroxyethyl methacrylate, 4-hydroxybutyl acrylate, 4-hydroxybutyl methacrylate and products derived therefrom by reaction with lactones; amide-containing ethylenically unsaturated monomers, such as acrylamide, methacrylamide, N-isopropylacrylamide, N-butylacrylamide, N,N-dibutylacrylamide, hydroxymethylacrylamide, methoxymethylacrylamide and butoxymethylacrylamide and like (meth)acrylamides; and nonfunctional ethylenically unsaturated monomers, such as styrene, alpha-methylstyrene, acrylate esters (e.g. methyl acrylate, ethyl acrylate, butyl acrylate, 2-ethylhexyl acrylate) and methacrylate esters (e.g. methyl methacrylate, ethyl methacrylate, butylmethacrylate, isobutylmethacrylate, tert-butyl methacrylate, 2-ethylhexyl methacrylate, lauryl methacrylate), and so forth, including mixtures thereof.

For obtaining the desired resin by emulsion polymerization, specifically a carboxyl-containing ethylenically unsaturated monomer, another ethylenically unsaturated monomer, and an emulsifier are often subjected to polymerization in water. As specific examples of the carboxyl-containing ethylenically unsaturated monomer and of the other ethylenically unsaturated monomer, there may be mentioned those already mentioned hereinabove. The emulsifier is not particularly restricted but may be any of those well known to a skilled person in the art.

Suitable carboxyl-containing polyurethane resins can be produced, for example, by reacting a compound having an isocyanato group at both termini and a compound having two hydroxy groups and at least one carboxyl group.

The compound having an isocyanato group at both termini can be prepared, for example, by reacting a hydroxy-terminated polyol and a diisocyanate compound, as will be understood by those skilled in the art. The compound having two hydroxy groups and at least one carboxyl group is, for example, dimethylolacetic acid, dimethylolpropionic acid or dimethylolbutyric acid.

The coating compositions of the present invention may comprise two or more species of the carboxyl-containing resin.

The acid value carboxyl-containing resin is not particularly restricted but is often from 2 to 200, such as 2 to 30 or 20 to 200.

In the coating compositions of the present invention, the carboxyl-containing polymer is in the form of an aqueous dispersion or solution of the polymer neutralized with a base. The base is not particularly restricted but includes, among others, organic amines such as monomethylamine, dimethylamine, trimethylamine, triethylamine, diisopropylamine, monoethanolamine, diethanolamine and dimethylethanolamine, and inorganic bases such as sodium hydroxide, potassium hydroxide and lithium hydroxide.

In the compositions of the present invention, the degree of neutralization is critical. In the compositions of the present invention, the base is present in an amount greater than the theoretical amount necessary to neutralize one hundred percent (100%) of the carboxylic acid groups of the polymer and sufficient to provide the composition with a pH of at least 9.0. In certain embodiments, the base is present in an amount sufficient to provide the composition with a pH of greater than 9.0, such as at least 9.5 or at least 10.0.

In certain embodiments, the mole ratio of the total number of carboxylic acid groups within the coating composition to the total number of carbodiimide groups within the composition is 0.05 to 5/1, such as 0.05 to 4/1. In fact, a surprising discovery of the present invention is that coating compositions exhibiting dramatically improved storage stability can be achieved when the amount of carbodiimide crosslinking agent in the composition is high relative to the amount of carboxylic acid groups present in the composition. It has been discovered that coating compositions exhibiting substantially improved storage stability can been achieved when the mole ratio of the total number of carboxylic acid groups within the coating composition to the total number of carbodiimide groups within the composition is no more than 2/1, such as no more than 1.5/1, in some cases 0.5 to 1.5/1, or, in yet other cases, 0.8 to 1.2/1. This is desirable because coating compositions having a higher ratio of carbodiimide crosslinking agent relative to carboxylic acid groups would be expected to provide coatings having superior physical properties upon cure, relative to similar coating containing a lower ratio of carbodimide groups relatively to carboxylic acid groups.

The thermosetting coating composition of the present invention can further include a crosslinking agent, different from the polycarbodiimides described above, corresponding to the functional group within the carboxyl-containing aqueous resin composition. When, for example, the carboxyl-containing resin is a hydroxy-containing one, the auxiliary crosslinking agent may be an amino resin or (blocked) polyisocyanate, for instance. It may comprise a single species or two or more species. As specific examples of the amino resin, there may be mentioned alkoxylated melamine-formaldehyde or paraformaldehyde condensation products, for example condensation products from an alkoxylated melamine-formaldehyde such as methoxymethylolmelamine, isobutoxymethylolmelamine or n-butoxymethylolmelamine, as well as such commercial products available under the trademark Cymel 303. As specific examples of the above (blocked) polyisocyanate compound, there may be mentioned polyisocyanates such as trimethylene diisocyanate, hexamethylene diisocyanate, xylylene diisocyanate and isophoronediisocyanate, and derivatives thereof obtained by addition of an active hydrogen-containing blocking agent such as an alcohol compound or an oxime compound and capable of regenerating an isocyanato group by dissociation of the blocking agent upon heating. The content of the auxiliary crosslinking agent is not particularly restricted but may adequately be selected by one having an ordinary skill in the art according to the functional group value of the carboxyl-containing aqueous resin composition, the auxiliary crosslinking agent species and so forth.

In certain embodiments, the resin solids are present in the coating compositions of the present invention in an amount of at least 50 percent by weight, such as 50 to 75 percent by weight, based on the total weight of the coating composition.

In certain embodiments, the coating compositions of the present invention also comprise a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coating compositions of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No, 60/482,167 filed Jun. 24, 2003, and U.S. patent application Ser. No. 11/337,062, filed Jan. 20, 2006, which is also incorporated herein by reference.

Example special effect compositions that may be used in the coating compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In certain embodiments, special effect compositions can produce a color shift, such that the color of the coating changes when the coating is viewed at different angles. Example color effect compositions are identified in U.S. Pat. No. 6,894,086, which is incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain embodiments, a photosensitive composition and/or photochromic composition, which reversibly alters its color when exposed to one or more light sources, can be used in the coating compositions of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In certain embodiments, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In certain embodiments, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with certain embodiments of the present invention, have minimal migration out of the coating. Example photosensitive compositions and/or photochromic compositions and methods for making them are identified in United States Published Patent Application No. 2006-0014099 A1, which is incorporated herein by reference.

In general, the colorant can be present in the coating composition in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The coating compositions of the present invention may further contain other optional ingredients such as organic solvents, antifoaming agents, pigment dispersing agents, plasticizers, ultraviolet absorbers, antioxidants, surfactants and the like. These optional ingredients when present are often present in amounts up to 30 percent, typically 0.1 to 20 percent by weight based on total weight of the coating composition.

Examples of suitable solvents are polar water miscible solvents used in the preparation of the polycarbodiimide, such as N-methylpyrrolidone. Additional solvent, such as N-methylpyrrolidone and various ketones and esters such as methyl isobutyl ketone and butylacetate can be added. When present, the organic solvent is sometimes present in amounts of 5 to 25 percent by weight based on total weight of the coating composition.

The coating compositions of the present invention can be produced by any method well known to the one having an ordinary skill in the art using the above components as raw materials. Suitable methods are described in the Examples herein. In certain embodiments, the compositions are prepared by combining an aqueous polycarbodiimide dispersion having a pH of greater than 7.0, such as at least 8.0, or, in some cases, at least 9.0, with an aqueous dispersion of a base neutralized carboxylic functional polymer, wherein a base is present in the aqueous dispersion of the base neutralized carboxylic functional polymer in an amount sufficient to theoretical neutralize about one hundred percent (100%) of the carboxylic acid groups of the polymer. Thereafter, additional base is added to the mixture in an amount sufficient to provide a coating composition of the present invention.

The present invention also relates to methods of using the foregoing coating compositions. These methods comprise applying the coating composition to the surface of a substrate or article to be coated, allowing the composition to coalesce to form a substantially continuous film and then allowing the film to cure.

The coating compositions of the present invention are suitable for application to any of a variety of substrates, including human and/or animal substrates, such as keratin, fur, skin, teeth, nails, and the like, as well as plants, trees, seeds, agricultural lands, such as grazing lands, crop lands and the like; turf-covered land areas, e.g., lawns, golf courses, athletic fields, etc., and other land areas, such as forests and the like.

Suitable substrates include cellulosic-containing materials, including paper, paperboard, cardboard, plywood and pressed fiber boards, hardwood, softwood, wood veneer, particleboard, chipboard, oriented strand board, and fiberboard. Such materials may be made entirely of wood, such as pine, oak, maple, mahogany, cherry, and the like. In some cases, however, the materials may comprise wood in combination with another material, such as a resinous material, i.e., wood/resin composites, such as phenolic composites, composites of wood fibers and thermoplastic polymers, and wood composites reinforced with cement, fibers, or plastic cladding.

Suitable metallic substrates include, but are not limited to, foils, sheets, or workpieces constructed of cold rolled steel, stainless steel and steel surface-treated with any of zinc metal, zinc compounds and zinc alloys (including electrogalvanized steel, hot-dipped galvanized steel, GALVANNEAL steel, and steel plated with zinc alloy), copper, magnesium, and alloys thereof, aluminum alloys, zinc-aluminum alloys such as GALFAN, GALVALUME, aluminum plated steel and aluminum alloy plated steel substrates may also be used. Steel substrates (such as cold rolled steel or any of the steel substrates listed above) coated with a weldable, zinc-rich or iron phosphide-rich organic coating are also suitable for use in the process of the present invention. Such weldable coating compositions are disclosed in, for example, U.S. Pat. Nos. 4,157,924 and 4,186,036. Cold rolled steel is also suitable when pretreated with, for example, a solution selected from the group consisting of a metal phosphate solution, an aqueous solution containing at least one Group IIIB or IVB metal, an organophosphate solution, an organophosphonate solution, and combinations thereof. Also, suitable metallic substrates include silver, gold, and alloys thereof.

Examples of suitable silicatic substrates are glass, porcelain and ceramics.

Examples of suitable polymeric substrates are polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers—such as gelatin.

Examples of suitable textile substrates are fibers, yarns, threads, knits, wovens, nonwovens and garments composed of polyester, modified polyester, polyester blend fabrics, nylon, cotton, cotton blend fabrics, jute, flax, hemp and ramie, viscose, wool, polyamide, polyamide blend fabrics, polyacrylonitrile, triacetate, acetate, polycarbonate, polypropylene, polyvinyl chloride, polyester microfibers and glass fiber fabric.

Examples of suitable leather substrates are grain leather (e.g. nappa from sheep, goat or cow and box-leather from calf or cow), suede leather (e.g. velours from sheep, goat or calf and hunting leather), split velours (e.g. from cow or calf skin), buckskin and nubuk leather; further also woolen skins and furs (e.g. fur-bearing suede leather). The leather may have been tanned by any conventional tanning method, in particular vegetable, mineral, synthetic or combined tanned (e.g. chrome tanned, zirconyl tanned, aluminium tanned or semi-chrome tanned). If desired, the leather may also be re-tanned; for re-tanning there may be used any tanning agent conventionally employed for re-tanning, e.g. mineral, vegetable or synthetic tanning agents, e.g., chromium, zirconyl or aluminium derivatives, quebracho, chestnut or mimosa extracts, aromatic syntans, polyurethanes, (co) polymers of (meth)acrylic acid compounds or melamine, dicyanodiamide and/or urea/formaldehyde resins.

In certain embodiments, the coating compositions of the present invention are particularly suitable for application to “flexible” substrates. As used herein, the term “flexible substrate” refers to a substrate that can undergo mechanical stresses, such as bending or stretching and the like, without significant irreversible change. In certain embodiments, the flexible substrates are compressible substrates. “Compressible substrate” and like terms refer to a substrate capable of undergoing a compressive deformation and returning to substantially the same shape once the compressive deformation has ceased. The term “compressive deformation” and like terms mean a mechanical stress that reduces the volume at least temporarily of a substrate in at least one direction. Examples of flexible substrates includes non-rigid substrates, such as woven and nonwoven fiberglass, woven and nonwoven glass, woven and nonwoven polyester, thermoplastic urethane (TPU), synthetic leather, natural leather, finished natural leather, finished synthetic leather, foam, polymeric bladders filled with air, liquid, and/or plasma, urethane elastomers, synthetic textiles and natural textiles. Examples of suitable compressible substrates include foam substrates, polymeric bladders filled with liquid, polymeric bladders filled with air and/or gas, and/or polymeric bladders filled with plasma. As used herein the term “foam substrate” means a polymeric or natural material that comprises a open cell foam and/or closed cell foam. As used herein, the term “open cell foam” means that the foam comprises a plurality of interconnected air chambers. As used herein, the term “closed cell foam” means that the foam comprises a series of discrete closed pores. Example foam substrates include but are not limited to polystyrene foams, polyvinyl acetate and/or copolymers, polyvinyl chloride and/or copolymers, poly(meth)acrylimide foams, polyvinylchloride foams, polyurethane foams, and polyolefinic foams and polyolefin blends. Polyolefinic foams include but are not limited to polypropylene foams, polyethylene foams and ethylene vinyl acetate (“EVA”) foams. EVA foam can include flat sheets or slabs or molded EVA foams, such as shoe midsoles. Different types of EVA foam can have different types of surface porosity. Molded EVA can comprise a dense surface or “skin”, whereas flat sheets or slabs can exhibit a porous surface. “Textiles” can include natural and/or synthetic textiles such as fabric, vinyl and urethane coated fabrics, mesh, netting, cord, yarn and the like, and can be comprised, for example, of canvas, cotton, polyester, KELVAR, polymer fibers, polyamides such as nylons and the like, polyesters such as polyethylene terephthalate and polybutylene terephthalate and the like, polyolefins such as polyethylene and polypropylene and the like, rayon, polyvinyl polymers such as polyacrylonitrile and the like, other fiber materials, cellulosics materials and the like.

The coating compositions of the present invention have a wide variety of applications. For example, the flexible substrate can be incorporated into and/or form part of sporting equipment, such as athletic shoes, balls, bags, clothing and the like; apparel; automotive interior components; motorcycle components; household furnishings such as decorative pieces and furniture upholstery; wallcoverings such as wallpaper, wall hangings, and the like; floor coverings such as rugs, runners, area rugs, floor mats, vinyl and other flooring, carpets, carpet tiles and the like.

The coating compositions of the present invention can be applied to such substrates by any of a variety of methods including spraying, brushing, dipping, and roll coating, among other methods. In certain embodiments, however, the coating compositions of the present invention are applied by spraying and, accordingly, such compositions often have a viscosity that is suitable for application by spraying at ambient conditions.

After application of the coating composition of the present invention to the substrate, the composition is allowed to coalesce to form a substantially continuous film on the substrate. Typically, the film thickness will be 0.01 to 20 mils (about 0.25 to 508 microns), such as 0.01 to 5 mils (0.25 to 127 microns), or, in some cases, 0.1 to 2 mils (2.54 to 50.8 microns) in thickness. The coating compositions of the present invention may be pigmented or clear, and may be used alone or in combination as primers, basecoats, or topcoats.

The coating compositions of the present invention are curable in the presence of ambient air, the air having a relative humidity of 10 to 100 percent, such as 25 to 80 percent, and a temperature in the range of −10 to 120° C., such as 5 to 80° C., in some cases 10 to 60° C. and, in yet other cases, 15 to 40° C. and can be cured in a relatively short period of time to provide films that have good early properties which allow for handling of the coated objects without detrimentally affecting the film appearance and which ultimately cure to films which exhibit excellent hardness, solvent resistance and impact resistance.

Illustrating the invention are the following examples that are not to be considered as limiting the invention to their details. All parts and percentages in the examples, as well as throughout the specification, are by weight unless otherwise indicated.

### Example 1

A polycarbodiimide aqueous dispersion was prepared using the procedure described below and the ingredients and amounts listed in Table 1.

TABLE 1

| | |
|---|---|
| Ingredients | Parts by Weight |

Charge #1

| | |
|---|---|
| Desmodur W¹ | 140 |
| Phospholene oxide | 0.7 |

Charge #2

| | |
|---|---|
| Dibutyltin dilaurate | 0.01 |

Charge #3

| | |
|---|---|
| Methylisobutylketone | 85 |

Charge #4

| | |
|---|---|
| Ethylene Glycol | 4.4 |

Charge #5

| | |
|---|---|
| Jeffamine M1000 (XTJ-506)² | 123.2 |

Charge #6

| | |
|---|---|
| Deionized water | 460 |
| Abex 2005³ | 16.7 |

¹Methylene-bis-(4-cyclohexyldiisocyanate) from Bayer Materials Science, LLC.
²A polyetheramine from Huntsman (mole ratio of EO/PO = 6.3, MW = 1000)
³Anionic surfactant from Rhodia

Charge #1 was added to a 2-liter, 4-necked flask equipped with a motor driven stainless steel stir blade, a water-cooled condenser, a nitrogen inlet, and a heating mantle with a thermometer connected through a temperature feedback control device. The contents of the flask were heated to 160° C. and held at that temperature until the isocyanate equivalent weight measured >450 eq/g by titration. The temperature was then decreased to 95° C. and Charge #2 was added. Charge #3 was added over 10 minutes and #4 was added over 30 minutes while maintaining the reaction temperature at 90-100° C. The resulting mixture was held until the NCO equivalent weight stalled at about 1727 eq/g. Charge #5 was added and the mixture was held at 90-100° C. until IR spectroscopy showed the absence of the characteristic NCO band. The methylisobutylketone was stripped under the vacuum. The batch was cooled to 80-90° C., and Charge #6, after being preheated to 85-90° C., was added to the reaction flask over 20 minutes while maintaining the temperature below 90° C. A sample of the polycarbodiimide dispersion was placed in a 120° F. hot room for 4 weeks, and the resin remained dispersed.

### Example 2

A polycarbodiimide aqueous dispersion was prepared using the procedure described below and the ingredients and amounts listed in Table 2.

TABLE 2

| | |
|---|---|
| Ingredients | Parts by Weight |

Charge #1

| | |
|---|---|
| TMXDI¹ | 280 |
| Phospholene oxide | 4.2 |

Charge #2

| | |
|---|---|
| Dibutyltin dilaurate | 0.024 |

Charge #3

| | |
|---|---|
| Methylisobutylketone | 85 |

Charge #4

| | |
|---|---|
| Ethylene Glycol | 8.4 |

Charge #5

| | |
|---|---|
| Jeffamine M1000 (XTJ-506)² | 244.2 |

Charge #6

| | |
|---|---|
| Deionized water | 960 |
| Abex 2005³ | 33.3 |

¹Meta-tetramethylxylene diisocyanate from Cytec Industries Inc.
²A polyetheramine from Huntsman (mole ratio of EO/PO = 6.3, MW = 1000)
⁴Anionic surfactant from Rhodia

Charge #1 was added to a 2-liter, 4-necked flask equipped with a motor driven stainless steel stir blade, a water-cooled condenser, a nitrogen inlet, and a heating mantle with a thermometer connected through a temperature feedback control device. The contents of the flask were heated to 160° C. and held at that temperature until the isocyanate equivalent weight measured >450 eq/g by titration. The temperature was then decreased to 95° C. and Charge #2 was added. Charge #3 was added over 10 minutes and #4 was added over 30 minutes while maintaining the reaction temperature at 90-100° C. The resulting mixture was held until the NCO equivalent weight stalled at about 1300 eq/g. Charge #5 was added and the mixture was held at 90-100° C. until IR spectroscopy showed the absence of the characteristic NCO band. The methylisobutylketone was stripped under the vacuum. The batch was cooled to 60-65° C., and Charge #6, after being preheated to 60-65° C., was added to the reaction flask over 20 minutes while maintaining the temperature below 65° C. A sample of the polycarbodiimide dispersion was placed in a 120° F. hot room for 4 weeks, and the resin remained dispersed.

### Example 3

A polyurethane aqueous dispersion was prepared using the using the procedure described below and the ingredients and amounts listed in Table 3.

TABLE 3

| | |
|---|---|
| Ingredients | Parts by Weight |

Charge #1

| | |
|---|---|
| Terathane 1000¹ | 357 |
| DMPA² | 63.9 |

Charge #2

| | |
|---|---|
| IPDI³ | 237.8 |

Charge #3

| | |
|---|---|
| m-Pyrol | 160.7 |

Charge #4

| | |
|---|---|
| Dibutyltindilaurate | 1.07 |

Charge #5

| | |
|---|---|
| Deionized water | 1072.4 |
| Adipic dihydrazide⁴ | 33.3 |
| Triethyl amine | 50.9 |

Charge #6

| | |
|---|---|
| Deionized water | 58 |

¹A polytetramethylene ether glycol from BASF Corp.
²Dimethylol propionic acid from Perstorp polyols.
³Isophorone diisocyanate from Bayer.
⁴Adipic acid dihydrazide was from Japan Fine Chem.

Charge #1 was added to a 5-liter, 4-necked flask equipped with a motor driven stainless steel stir blade, a water-cooled condenser, a nitrogen inlet, and a heating mantle with a thermometer connected through a temperature feedback control device. The content of the flask was heated to 60° C. and charge #2 was added via a funnel over 10 minutes, and the funnel was then rinsed with charge #3. Charge #4 was then added to the reaction mixture. The reaction was allowed to exotherm. After the exotherm had subsided, the reaction mixture was heated back to 80° C. and held at that temperature until the isocyanate equivalent weight measured >1300-1500 eq/g by titration. The temperature was then reduced to 50° C. and preheated (40° C.) Charge #5 was added over 20 minutes while keeping the reaction temperature 50° C. Charge #6 was used as a rinse; the resulting mixture was held additional 30 minutes at 50° C. and cooled to room temperature.

The polymeric dispersions of Examples 1, 2 and 3 had the attributes set forth in Table 4.

TABLE 4

| | Example 1 | Example 2 | Example 3 |
|---|---|---|---|
| Molecular Weight | 6613 | 6178 | 30,795 |
| pH | 9.7 | 9.57 | 6.9 |
| Solids % | 35 | 34 | 35 |
| Particle Size | 7.8 nm | 5 nm | 3.359 um |
| Theoretical carbodiimide | 1859/650 | 1706/597 | — |
| equivalent weight (on total | | | |
| solution weight/on solids) | | | |
| Theoretical carboxylic acid | — | — | 4126/1444 |
| equivalent weight (on total | | | |
| solution weight/on solids) | | | |

### Examples 4-6

Coating compositions were prepared using the procedure described below and the ingredients and weight percentages listed in Table 5.

TABLE 5

| | Exam- | | |
|---|---|---|---|
| Ingredient | ple 4 | Example 5 | Example 6 |
| Dispersion of Example 3 | 93.02 | 90.1 | 74.07 |
| Carbodilite V-02-L2¹ | 6.98 | 0 | 0 |
| Dispersion of Example 1 | 0 | 9.9 | 0 |
| Dispersion of Example 2 | 0 | 0 | 25.93 |
| Carboxylic Acid/ | 3.55 | 4.13 | 1.19 |
| Carbodiimide | | | |
| Mole Ratio | | | |

¹Polycarbodiimide crosslinker, solids 40%, carbodiimide equivalent 385 (relative to resin solids), commercially available from Nisshinbo Industries, Inc.

The polyurethane dispersion from Example 3 was mixed under stirring with the selected carbodiimide dispersion. The pH of the resulting mixtures was about 8.5 in each case and was measured with a pH-meter. To further increase the pH to 10 for some Examples, 100% DMEA (dimethyl ethanol amine) was added dropwise while monitoring the pH. Samples having pHs of 8.5 and 10 were placed in hot rooms at 120° F. and 160° F. for accelerated stability testing. It is believed that 1 month at 120° F. corresponds to 6 months at ambient conditions and 1 month at 160° F. corresponds to 1 year at ambient conditions. The mixtures were periodically inspected and the onset of gelling was recorded. The results are presented in Table 6.

TABLE 6

| | Example 4 | Example 4 | Example 5 | Example 5 | Example 6 | Example 6 |
|---|---|---|---|---|---|---|
| Time/Temp. | (pH 8.5) | (pH 10) | (pH 8.5) | (pH 10) | (pH 8.6) | (pH 10) |
| 10 days/120° F. | Gel* | Stable | Stable | Stable | Stable | Stable |
| 10 days/160° F. | Gel | Gel | Gel | Stable | Stable | Stable |
| 1 month/120° F. | — | Gel | Stable | Stable | Stable | Stable |
| 1 month/160° F. | — | — | — | Gel | Gel | Stable |
| 2 month/120° F. | — | — | Gel | Stable | Stable | Stable |
| 2 month/160° F. | — | — | — | — | — | Stable |
| 3 month/120° F. | — | — | — | Stable | Stable | Stable |
| 3 month/160° F. | — | — | — | — | — | Stable |
| 4 month/120° F. | — | — | — | Stable | Gel | Stable |
| 4 month/160° F. | — | — | — | — | — | Hard Settle* |

*“Gel” means the reaction between the carbodiimide and polyurethane has been completed. The mixture looks like a clear solid gel. Hard settle is when the polyurethane crashes at the bottom of the flask and there is a liquid at the top. They are both unusable as a coating.

As is seen from Table 6, the coating composition of Example 6 (using a TMXDI based polycarbodiimide crosslinker) at a pH less than 9 (8.6 in this case) exhibited a long term stability of less than 1 month at 160° F. It is believed that this means that the composition would exhibit a shelf life of less than one year. A coating composition having a pH of at least 9 (10 in these cases) but made with a carbodiimide not derived from TMXDI also exhibited a long term stability of less than 1 month at 160° F. Therefore, it would have been expected that a coating composition using a both a TMXDI based carbodiimide and a pH of at least 9 would exhibit a long term stability of less than 2 month at 160° F., because such a result would represent a sum of each of the effects of TMXDI and high pH taken separately. This, however, is not what was observed. What was observed was an unexpected synergistic effect from use of the combination of a TMXDI based carbodiimide and a pH of at least 9. This synergistic effect is shown by the results in which this coating composition exhibited a long term stability of over 3 months at 160° F.

We believe that this unexpected synergistic effect is of both statistical and practical significance. Statistically, our invention exhibited a long term stability at 160° F. that was more than 50% greater than the results we would have expected. We believe this is statistically significant. Practically, this means that our invention would be expected to be storage stable for more than 3 years at ambient conditions, thus making our invention commercially viable as a single component coating. This is because commercial requirements often dictate that a one-component coating exhibit at least two years shelf life. The comparative examples would not fulfill such a requirement because, based on the results illustrated in Table 6, they would be expected to have a shelf life of less than two years.

### Examples 7-9

Coating compositions were prepared using the procedure described below and the ingredients and weight percentages listed in Table 7.

TABLE 7

| | Exam- | | |
|---|---|---|---|
| Ingredient | ple 7 | Example 8 | Example 9 |
| Polyurethane dispersion¹ | 70 | 56.73 | 60.78 |
| Carbodilite V-02-L2² | 30 | 0 | 0 |
| Dispersion of Example 1 | 0 | 43.27 | 0 |
| Dispersion of Example 2 | 0 | 0 | 39.22 |
| Equivalent weight ratio | 1 | 1 | 1 |
| acid/carbodiimide | | | |

¹Prepared as described in U.S. Pat. No. 7,709,093, Example 1
²Polycarbodiimide crosslinker, solids 40%, carbodiimide equivalent 385 (relative to resin solids), commercially available from Nisshinbo Industries, Inc.

The polyurethane dispersion was mixed under stirring with the selected carbodiimide dispersion. The pH of the resulting mixtures ranged from 8.3 to 8.7 and was measured with a pH-meter. To further increase the pH, 50% DMEA (dimethyl ethanol amine) was added dropwise while monitoring the pH. Samples having pHs of 8.5, 9, 9.5 and 10 were placed in hot rooms at 120° F. and 160° F. for accelerated stability testing. It is believed that 1 month at 120° F. corresponds to 6 months at ambient conditions and 1 month at 160° F. corresponds to 1 year at ambient conditions. The mixtures were periodically inspected and the onset of gelling was recorded. The results are presented in Table 8.

TABLE 8

| Example | pH | Amine | | Hot Room Temp. | 24 hours | 5 days | 10 days | 15 days | 21 days | 26 days | 40 days |
|---|---|---|---|---|---|---|---|---|---|---|---|
| 7 | 8.3 | 0 | | 120° F. | Stable | Almost Gel | Gel | — | — | — | — |
| 7 | 9 | 0.5 | g | 120° F. | Stable | Stable | Almost Gel | Almost Gel | Gel | — | — |
| 7 | 9.5 | 1.07 | g | 120° F. | Stable | Stable | Stable | Almost Gel | Almost Gel | Almost Gel | Gel |
| 7 | 10 | 3.05 | g | 120° F. | Stable | Stable | Stable | Stable | Thick | Thick | Almost Gel |
| 8 | 8.7 | 0 | | 120° F. | Stable | Stable | Stable | Stable | Stable | Stable | Almost Gel |
| 8 | 9 | 0.2 | g | 120° F. | Stable | Stable | Stable | Stable | Stable | Stable | Almost Gel |
| 8 | 9.5 | 0.7 | g | 120° F. | Stable | Stable | Stable | Stable | Stable | Stable | Thick |
| 8 | 10 | 2.5 | g | 120° F. | Stable | Stable | Stable | Stable | Stable | Stable | Stable |
| 9 | 8.6 | 0 | | 120° F. | Stable | Stable | Stable | Stable | Thick | Thick | 150 cps** |
| 9 | 9 | 0.2 | g | 120° F. | Stable | Stable | Stable | Stable | Stable | Thick | 127 cps |
| 9 | 9.5 | 0.5 | g | 120° F. | Stable | Stable | Stable | Stable | Stable | Stable | 113 cps |
| 9 | 10 | 2.4 | g | 120° F. | Stable | Stable | Stable | Stable | Stable | Stable | 95 cps |
| 7 | 8.3 | 0 | | 160° F. | Gel* | — | — | — | — | — | — |
| 7 | 9 | 0.5 | g | 160° F. | Gel | — | — | — | — | — | — |
| 7 | 9.5 | 1.07 | g | 160° F. | Gel | — | — | — | — | — | — |
| 7 | 10 | 3.05 | g | 160° F. | Gel | — | — | — | — | — | — |
| 8 | 8.7 | 0 | | 160° F. | Gel | — | — | — | — | — | — |
| 8 | 9 | 0.2 | g | 160° F. | Gel | — | — | — | — | — | — |
| 8 | 9.5 | 0.7 | g | 160° F. | Gel | — | — | — | — | — | — |
| 8 | 10 | 2.5 | g | 160° F. | Almost Gel | Gel | — | — | — | — | — |
| 9 | 8.6 | 0 | | 160° F. | Stable | Stable | Stable | Stable | Stable | Stable | Gel |
| 9 | 9 | 0.2 | g | 160° F. | Stable | Stable | Stable | Stable | Stable | Stable | Gel |
| 9 | 9.5 | 0.5 | g | 160° F. | Stable | Stable | Stable | Stable | Stable | Stable | 425 cps |
| 9 | 10 | 2.4 | g | 160° F. | Stable | Stable | Stable | Stable | Stable | Stable | 110 cps |

*“Gel” means the reaction between the carbodiimide and polyurethane has been completed. The mixture looks like a clear solid gel. Hard settle is when the polyurethane crashes at the bottom of the flask and there is a liquid at the top. They are both unusable as a coating.
**Viscosities were measured after removing the sample from the hot room and allowing them to reach room temperature (25° C.). Viscosity measurements were made with a cone (50 mm diameter) and plate Paar Physica MCR 501 Rheometer (from Anton Paar) at a shear rate of 10 s-1.

As is seen from Table 8, the coating composition of Example 9 (using a TMXDI based polycarbodiimide crosslinker) at a pH less than 9.5 exhibited a long term stability of less than 40 days at 160° F. It is believed that this means that the composition would exhibit a shelf life of less than one year. The coating compositions having a pH of at least 9.5 but made with a carbodiimide not derived from TMXDI exhibited a stability of less than 24 hours at 160° F. Therefore, it would have been expected that a coating composition using a both a TMXDI based carbodiimide and a pH of at least 9.5 would also exhibit a long term stability of less than 40 days at 160° F., because such a result would represent a sum of each of the effects of TMXDI and high pH taken separately. This, however, is not what was observed. What was observed was an unexpected synergistic effect from use of the combination of a TMXDI based carbodiimide and a pH of at least 9.5. This synergistic effect is shown by the results in which this coating composition exhibited a long term stability of over 40 days at 160° F.

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

We claim:

1. A one component waterborne coating composition comprising:
(a) a polycarbodiimide that is:
(i) modified for hydrophilicity; and
(ii) derived from a tetramethylxylylene diisocyanate;
(b) a carboxylic acid functional polymer; and
(c) a base in an amount greater than the theoretical amount necessary to neutralize 100% of the acid groups of the carboxylic acid functional polymer and sufficient to provide the composition with a pH of at least 9.0.

2. The coating composition of claim 1, wherein the tetramethylxylylene diisocyanate comprises m-tetramethylxylylene diisocyanate.

3. The coating composition of claim 1, wherein the polycarbodiimide is the reaction product of an isocyanate terminated polycarbodiimide with a monofunctional active hydrogen containing compound.

4. The coating composition of claim 3, wherein the monofunctional active hydrogen containing compound comprises a polyether amine having a molecular weight greater than 500.

5. The coating composition of claim 4, wherein the polyether amine has the structure: 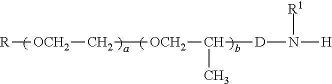
wherein R is C₁ to C₄ alkyl; a is 5 to 50 and b is 0 to 35, and when b is present the mole ratio of a to b is at least 1:1; R¹ is hydrogen or a hydrocarbon radical and D is a divalent linking group or a chemical bond.

6. The coating composition of claim 1, wherein the carboxylic acid functional polymer comprises polyurethane.

7. The coating composition of claim 1, wherein the base is present in an amount sufficient to provide the composition with a pH of at least 95.

8. The coating composition of claim 7, wherein the base is present in an amount sufficient to provide the composition with a pH of at least 10.0.

9. A method of using the coating composition of claim 1, comprising:
(a) applying the coating composition to the surface of a substrate to be coated,
(b) allowing the composition to coalesce to form a substantially continuous film; and
(c) allowing the film to cure.

10. A method of making a coating composition comprising:
(a) combining:
(i) an aqueous dispersion of a polycarbodiimide that is modified for hydrophilicity and derived from a tetramethylxylylene diisocyanate, wherein the aqueous dispersion has a pH of greater than 7.0, with
(ii) an aqueous dispersion of a base neutralized carboxylic acid functional polymer; and
(b) adding a base to the combination resulting from step (a) in an amount sufficient to provide the combination with a pH of at least 9.0.

11. The method of claim 10, wherein the aqueous dispersion (a)(i) has a pH of at least 9.0.

12. The method of claim 10, wherein the base is added in step (b) in an amount sufficient to provide the combination with a pH of at least 9.5.

13. The method of claim 12, wherein the base is added in step (b) in an amount sufficient to provide the combination with a pH of at least 10.0.

14. The method of claim 13, wherein the polycarbodiimide is the reaction product of an isocyanate terminated polycarbodiimide with a monofunctional active hydrogen containing compound comprising a polyether amine having a molecular weight greater than 500.
